(19) United States
(12) Patent Application Publication
(10) Pub. No.: US 2025/0180220 A1
(43) Pub. Date: Jun. 5, 2025

(54) OPERATING DEVICE FOR AN ELECTRICAL APPLIANCE, AND ELECTRICAL APPLIANCE

(71) Applicant: E.G.O. Elektro-Gerätebau GmbH, Oberderdingen (DE)

(72) Inventors: Robin Abendschön, Eppingen (DE); Achim Marx, Oberderdingen (DE); Tilo Fucik, Walzbachtal (DE); Kevin Grafmüller, Bretten (DE)

(21) Appl. No.: 18/942,883

(22) Filed: Nov. 11, 2024

(30) Foreign Application Priority Data
Dec. 4, 2023 (DE) 10 2023 133 859.5

(51) Int. Cl. F24C 7/08; F21V 8/00

(52) U.S. Cl. CPC F24C 7/083; F24C 7/085; G02B 6/0096

(57) ABSTRACT

An operating device for an electrical appliance such as an oven has a control panel with a front face and with a rear face, and a rotary control unit on the rear face of the panel, which has a rotary shaft which protrudes through a panel opening beyond the front face of the control panel and supports a control knob there. The rotary control unit has a light source, wherein an annular light guiding device is arranged in the panel opening which extends to behind the panel opening as far as the light source. The light guiding device is made of light guiding material and completely surrounds the rotary shaft. Illuminated areas made of light guiding material are provided in the control knob, and extend from a rear face of the control knob close to the light guiding device to a lateral face and/or front face of the control knob. Light can thus be passed easily through the panel to the control knob.

### CROSS-REFERENCE TO RELATED APPLICATIONS

This application claims priority to German Application No. 10 2023 133 859.5, filed Dec. 4, 2023, the contents of which are hereby incorporated herein in its entirety by reference.

### FIELD OF APPLICATION AND PRIOR ART

The invention relates to an operating device for an electrical appliance, for example an oven. The invention furthermore relates to an electrical appliance or to an oven with such an operating device.

The operating device has a control panel and a rotary control unit behind it, on the rotary shaft of which a control knob arranged at the front on the control panel is seated. This enables the rotary control unit to be operated, for example to allow setting of a power stage or temperature for a heating means or of an operating mode, for example a heating mode of an oven.

Operating devices with rotatable control knob, inside which an illuminated display unit is arranged, are known from U.S. Pat. No. 6,838,785. This is regarded as very expensive.

Operating devices having a rotatable control knob are known from EP 2 251 762 A2, where light can shine through the control panel into and through the control knob. This makes possible an illuminated display and/or lighting at the front of the control knob.

### OBJECT AND SOLUTION

The invention is based on the object of creating an operating device as mentioned at the outset and an electrical appliance provided therewith, with which problems from the prior art are solved and, in particular, it is possible to provide an illuminated effect or lighting at a control knob of a rotary control unit, without this involving a major design effort or assembly effort during assembly of the operating device.

This object is achieved by an operating device having the features of claim 1 and by an electrical appliance having the features of claim 22. Advantageous and preferred embodiments of the invention are the subject matter of further claims and are explained in greater detail below. Some of the features are described only for the operating device or only for an electrical appliance provided therewith. They are however intended to be applicable, by themselves and independently of one another, both for such an operating device as well as for such an electrical appliance. The wording of the claims is incorporated into the content of the description by express reference.

The operating device has a control panel, which in turn has a front face and a rear face. Furthermore, the operating device has a said rotary control unit which is arranged behind or on the rear face of the control panel. The rotary control unit has a rotary shaft extending or protruding through a panel opening in the form of an opening in the control panel. Advantageously, the rotary shaft protrudes beyond said front face of the control panel. A control knob, which may also be regarded as a rotary knob, is arranged or fitted on this rotary shaft. The control knob is therefore on the front face of the control panel, and the rotary control unit is behind it. Advantageously, it may be provided that the control panel is designed opaque except for the panel opening through which the rotary shaft extends. To do so, either corresponding opaque material for the control panel may be provided, for example metal or colored plastic, or alternatively this can be achieved using a coating, a film or the like on the rear face or on the front face.

In accordance with the invention, the rotary control unit has a light source, advantageously in the form of an LED. Such a light source of the rotary control unit is preferably provided on an area of the rotary control unit that faces the rear face of the control panel. This allows a light path from the light source to the control knob to be kept as short as possible. Furthermore, a light guiding device is arranged in the panel opening, and is at least at the rear of the control panel or extends to behind the panel opening as far as the light source or in the direction of this light source, preferably up to a short distance from the light source. The light guiding device has solid light guiding material, and therefore is made up not only of air or of an air gap. Due to this solid light guiding material, the light may be guided inside the light guiding device as precisely and with as few losses as possible, for the best possible lighting or illuminated display. The light guiding device here surrounds the rotary shaft at least partially, wherein it advantageously completely surrounds it. The light guiding device may then be designed annular and extending around the rotary shaft, at least inside the panel opening. It may also be provided here that the rotary shaft is in contact with the light guiding device, which thus forms a kind of pivot bearing for the rotary shaft in the panel opening. Advantageously, however, a short clearance is provided. The light guiding device thus uses the same opening through which the rotary shaft extends through the control panel. In the control knob, illuminated areas are in turn provided which is made up of light guiding material, preferably with the same considerations as before, i.e. they do not consist only of air or of an air gap. In particular, these illuminated areas should fit well into the contour of the control knob, or of its outer face or surface, for an attractive visual appearance. These illuminated areas made of light guiding material extend from a rear face of the control knob, facing towards the control panel, to a lateral face or outer face of the control knob, alternatively or additionally to a front face of the control knob. Preferably, these illuminated areas extend close to the said light guiding device, which guides the light from the light source of the rotary control unit at least into the panel opening. The light guiding device is thus used effectively for bridging or for traversing the control panel, while the light is so to speak shone into the illuminated areas in the control knob in front of or on the control panel, and then shines out at their outlets on the said lateral face or front face, making it visible to an operator.

Thanks to the said design of the light guiding device and its arrangement in the same panel opening through which the rotary shaft for the control knob extends, a simple and practical possibility for illuminating a control knob or providing it with an illuminated display can be created. The rotary shaft itself does not guide the light here. Due to the fact that the at least one light source is provided at the rotary control unit, which in any case must be fastened on or behind the control panel, there is no increased assembly effort involved at least during final assembly of the operating device. An advantageously used rotary control unit has in any case an electrical connection and supply leads as well as options for mechanical fastening.

In an advantageous embodiment of the invention, the panel opening has a diameter between 10% and 100% greater than the maximum diameter of the rotary shaft. The resultant intermediate space is used for the light guiding device. It may be provided here that the rotary shaft extends with its axis of rotation through the center point of the panel opening, wherein the panel opening should then be designed circular. The rotary shaft is arranged concentrically therein, so that it may be advantageously provided that it can have a consistent thickness at least inside the panel opening. This applies above all for a light guiding device of annular design.

In a further embodiment of the invention, it may be provided that the light guiding device does not protrude beyond the front face of the control panel, or if so only by no more than 5 mm. If it does not protrude at all, there is no restriction imposed for the design of the control knob. If it protrudes only slightly, as indicated, it may be possible to move it somewhat closer to the control knob or to its illuminated areas. With such a short protrusion, or without any protrusion, a “push-to-turn” function may be achieved at the control knob or at the operating device if required, see also U.S. Pat. No. 6,211,582 in this respect.

Advantageously, it is provided here that in the event that there is a protrusion beyond the control panel at the front face, the light guiding device does not extend laterally or radially outside the panel opening; it may then be fitted easily from the rear and through the panel opening, wherein such an assembly direction may correspond to the assembly direction of the rotary control unit. This allows both of them to be designed as one structural unit. If the light guiding device does not protrude beyond the front face of the control panel or terminates behind this front face or in the panel opening, there is less of a risk of light shining out at the side between the front face and the control knob. This is not wanted at this point, and instead is regarded as an unwelcome and obtrusive light effect.

In a possible further development of the invention, it may be provided that the light guiding device is arranged permanently and unrotatably in the panel opening. This applies above all for the completely assembled and ready-to-use operating device, i.e. in particular at the electrical appliance. The light guiding device may be fastened in the panel opening itself and hence on the control panel, for example positively fastened or glued in place. Alternatively, it may be fastened to the rotary control unit and also arranged with its permanent and unrotatable fastening in the same way on the control panel. This applies in particular for the case that the light guiding device forms, with the rotary control unit, a structural unit which is then fastened as a whole to the operating device or to the control panel.

If it is provided that the light guiding device extends completely around the rotary shaft in the panel opening, it may also be achieved at the same time that less dirt can pass through the panel opening to behind the control panel. This might be detrimental to the functioning of the rotary control unit. Additionally or also independently thereof, it may be provided that the light guiding device takes up/fills between 50% and 95% of an intermediate space between an inner rim of this panel opening and the rotary shaft. This also allows better sealing against dirt. Advantageously, the light guiding device also extends however in this case completely around the rotary shaft or completely along the common inner rim.

In a first possible embodiment of the invention, it may be provided that the light guiding device consists of only one or only of a single light guiding material. This means that when light shines at any point into the light guiding device, this light is guided everywhere, but also that a distinction between different areas is not possible. This is a good option, due to the simple design, if light is to shine in only from a single light source or if light is only to be emitted uniformly by the light guiding device to the aforementioned light guiding areas of the control knob. Advantageously, it may be provided that the entire light guiding device is a single component made of a single material which is light guiding.

In another, second embodiment of the invention, it may be provided that the light guiding device has several light guiding sections or areas that are separated from one another or are separated opaquely from one another so that they do not shine over and into one another. Here too, the light guiding device is advantageously a single component for ease of handling, in particular during assembly of the rotary control unit or of the operating device. The said light guiding sections should therefore be permanently connected to one another, for example they may be manufactured as a multicomponent molding in a single injection operation. They may each be separated from one another by thin areas of opaque plastic. It is preferably provided here that these light guiding sections each extend from a rear area facing towards the rotary control unit, into which the light from the respective light source may therefore be coupled, to a front area. This front area faces towards the control knob or its light guiding areas. Particularly preferably, it may be provided here that the light guiding sections form annular sections or annular sectors, possibly even of equal size. They are then separated by opaque separators, formed in particular by coatings or thin areas of opaque plastic or other material suitable for the purpose.

For the form of a light guiding device in accordance with the invention, it may be provided that it is a type of sleeve with outwardly protruding collar. The thinner sleeve area can be inserted into the panel opening. At its front end, light can exit and shine out into the light guiding areas in the control knob and forwards or sideways out of the latter. Due to the widened and outwardly protruding areas of the collar, it is possible that a light source has a somewhat greater distance from the rotary shaft, which facilitates arrangement of the light source.

Advantageously, at least one light source is arranged on the rotary control unit, wherein preferably several light sources are arranged thereon. These may be distributed around the rotary shaft, and thus serve either to shine light together and more evenly into the light guiding device, or to introduce light in different ways into various light guiding sections, as mentioned above, which are separated from one another. In any event, it is advantageous for the light guiding device to extend close to the at least one or to all light sources. A distance may be in particular between 0.1 mm and 5 mm, so that there is no direct contact that might damage or scratch either of the two parts. In one embodiment of the invention, four light sources may for example be arranged evenly around the rotary shaft on the rotary control unit.

Advantageously, the rotary control unit can cover or shield the at least one light source against or into the interior of the operating device or of the electrical appliance having said operating device. This should be in such a way that the rotary control unit is arranged between the light source and the interior of the operating device or the interior of the electrical appliance. Additionally or alternatively, the at least one light source may be arranged between the rotary control unit and the control panel. The light source may thus be arranged in the coolest possible area, i.e. between the control panel and the rotary control unit. Conventional mechanical controls, as are used for rotary control units, are as a rule rated for temperatures of T125 or even for T150, which corresponds to 125° C. or 150° C., respectively. Electronic devices such as the light sources or a control unit for them, for example on a component carrier or printed circuit board, are as a rule rated only for T105, which corresponds to 105° C., so that installation is advantageously as far away as possible from the heat source. An arrangement of the light sources or a control unit for them as close as possible to the control panel may additionally ensure shielding for further improved cooling, since the control panel represents a kind of heat sink.

For arrangement of the at least one light source, in particular also for its power supply, a flat component carrier is advantageously provided, which may be designed in particular as a printed circuit board. A light source may thus be designed for example as an SMD component and fastened to corresponding contact fields plus conductor tracks on the component carrier, as well as electrically connected. This is set forth in more detail in the following.

Such a flat component carrier may be arranged or fastened at the front on the rotary control unit, in particular arranged towards the control panel or between the control panel and the rotary control unit. The component carrier may be arranged outside on the housing or outside the housing of the rotary control unit, wherein the at least one light source is arranged on that side of the component carrier facing the control panel.

The component carrier can preferably be fastened directly to the rotary control unit and form a structural unit with the latter. To do so, it can be fastened, for example snapped in place, by means of a holding part, overlapping it from the front, on the rotary control unit or on its housing. The component carrier is then located between said holding part and the rotary control unit or its housing. Particularly preferably, the holding part may be fastened to opposite lateral faces of the rotary control unit or of its housing, advantageously detachable easily and without tools, for example by a snap connection. The holding part may have a planar holding section which presses the component carrier against the rotary control unit or its front face such that the holding section is located between the component carrier and the rear face of the control panel. The holding section can, with its surface, preferably shield the light source towards the control panel or its rear face. In this way, unwanted shining out can be prevented. The light guiding device may extend with one section between the light source and the holding section, so that the light from the light source is coupled in here.

Advantageously, it is provided that the light guiding device extends through the holding part and in particular through said planar holding section. In particular, the rotary shaft also passes through the holding part or holding section, and the light guiding device can also extend therethrough. It may extend up to the light source or up to all the light sources behind the holding section or between the holding section and the component carrier. It may furthermore be provided that the light guiding device can be arranged or held in the correct position and in particular positively in a said passage opening in the holding section. Above all, it can be held nonrotatably in the passage opening, which is important in particular if the light guiding device consists of several light guiding sections separate from one another, as has been explained in the foregoing.

It is thus possible that the component carrier is seated at the front on the rotary control unit, in particular pressing against the front face of the rotary control unit. This pressing can be achieved by the said holding part, wherein either the holding part presses directly against the component carrier or an area of the light guiding device gripping between them is provided, which is pressed by the holding part against the component carrier. The holding part is in turn fastened, preferably snapped, onto the rotary control unit or its housing on one side. The holding part can on the other side be fastened, for example screwed, to the control panel. Hence the holding part can not only hold the component carrier and if necessary also the light guiding device, but also be used for fastening the rotary control unit in the operating device. The said parts, i.e. the rotary control unit, component carrier, light guiding device and holding part, may form a complete structural unit which can then be fastened in preassembled form to the operating device or to the control panel during their assembly.

Advantageously, two to six light sources may be arranged on the component carrier. They are particularly advantageously arranged evenly relative to one another and at the same distance from the rotary shaft. This distance may preferably be between 2 mm and 8 mm for sufficiently good shielding, for example by the aforementioned holding part.

In an advantageous embodiment of the invention, an electrical contact device may be arranged or provided on the component carrier, in particular to control the light sources or supply them with power. Such a contact device is preferably provided on an outer face or outer edge of the component carrier, as it is easily reachable here. Such an electrical contact device may be designed for a plug-in contact. It may for example have contact fields on the component carrier, at or onto which a contact plug can be fitted in such a way that it overlaps these contact fields. A contact is then very simple to make, and the contact device too does not require great expense. If the component carrier has conductor tracks and contact fields in any case, then said contact fields can also easily be made for a plug-in contact.

In one development of the invention, it may be provided that a microcontroller is also arranged on the component carrier. This may be used for controlling the at least one light source. Further components, which may advantageously be used to control the light sources, for example series resistors or the like, may also be arranged on it. However, this does not have to be the case. It is also possible, with the component carrier arranged additionally to the rotary control unit, for additional functions to be provided which the rotary control unit per se does not yet have. In this way, an existing rotary control unit may be used and provided with additional further functions.

To achieve the most advantageous structural unit possible of rotary control unit and component carrier, it may be provided that the component carrier is already undetachably fastened to the holding part. It may for example be snapped or clamped into place. The two parts can by themselves and between themselves hold the light guiding device and form a structural unit together with the latter. This may in turn be fastened to the rotary control unit, for example snapped on as has been previously described, to form a further structural unit. It may also be provided here that the holding part is made of plastic, which is advantageous if contact fields and/or conductor tracks are provided on the component carrier or on its face towards the holding part. Alternatively, the holding part may also be made up of thin metal and have a certain distance from the electrical insulation at least towards the front face of the component carrier.

Lateral edges of the component carrier that are free of electrically conducting areas may be held, in particular clamped, between protruding sections of the holding part, by means of which sections the holding part can for example be snapped into place on the housing of the rotary control unit. This can also be a positionally correct fastening. The component carrier may be fastened to the holding part by means of snapping, glueing or riveting.

In an advantageous embodiment of the invention, the component carrier has a certain distance not only from the holding part itself, as set forth in the foregoing, but also from the rotary control unit or its front face. This achieves a sufficient distance for components, contacts or the like. It may be provided only that a sleevelike projection is provided on the front face of the rotary control unit, in particular surrounding a rotary shaft protruding therefrom, on which projection the component carrier can be supported and/or positioned. A said distance may be between 0.5 mm and 5 mm.

An advantageous fastening of the rotary control unit to the control panel may be achieved by means of a screw connection with at least one screw. This screw may extend from the front face of the control panel through a screw opening therein and engage in a thread on the rotary control unit or on a structural unit with the rotary control unit. In particular, such a screw may also extend through the component carrier, however without being connected to it by means of a thread. A thread for the screw may be provided in particular on said holding part or on its planar holding section. The latter can thus also be used for fastening the entire rotary control unit. Alternatively, a thread for the screw may be provided on the front face of the rotary control unit, so that the holding part then fixes only the component carrier to the rotary control unit.

For an electrical appliance in accordance with the invention, at least one such operating device is provided. The latter or its control panel is arranged on an outer face of the electrical appliance, which is preferably an upper face or a front face of the electrical appliance. A control panel may then be formed either by an upper face of a housing or by a front face of a housing of the electrical appliance. Alternatively, it may be inserted into these faces of a housing as a separate surface.

There are numerous options known per se from the prior art for transmission of the light inside the control knob. The light arrives as described from the light guiding device close to the rotary shaft on the control knob and can then be passed on accordingly.

These and further features are revealed in the description and in the drawings as well as in the claims, wherein the individual features can be realized singly or severally in the form of subcombinations in one embodiment of the invention and in other fields, and can constitute advantageous embodiments eligible for protection in themselves, for which protection is here sought. The subdivision of the application into subheadings and individual sections does not limit the statements made thereunder in their general validity.

### BRIEF DESCRIPTION OF THE DRAWINGS

Examples of the invention are illustrated schematically in the drawings and explained in more detail below. In the drawings:

FIG. 1 shows a sectional view through an oven in accordance with the invention with an operating device in accordance with the invention, with a rotary control unit behind a control panel, with a rotary knob in front of the control panel and with a light guiding ring in a panel opening,

FIG. 2 shows a greatly simplified representation of a rotary control unit with printed circuit board, LED thereon and light guiding ring around a rotary shaft,

FIG. 3 shows a plan view from the front onto the rotary control unit from FIG. 2,

FIG. 4 shows a detailed oblique view of a light guiding ring,

FIG. 5 shows a detailed oblique view of a printed circuit board with four LEDs thereon,

FIG. 6 shows a detailed oblique view of a holding part for the printed circuit board from FIG. 5, and

FIG. 7 shows a detailed oblique view of a rotary control unit corresponding to FIG. 1, on the front face of which the holding part is arranged with light guiding ring and printed circuit board.

### DETAILED DESCRIPTION OF THE EXAMPLES

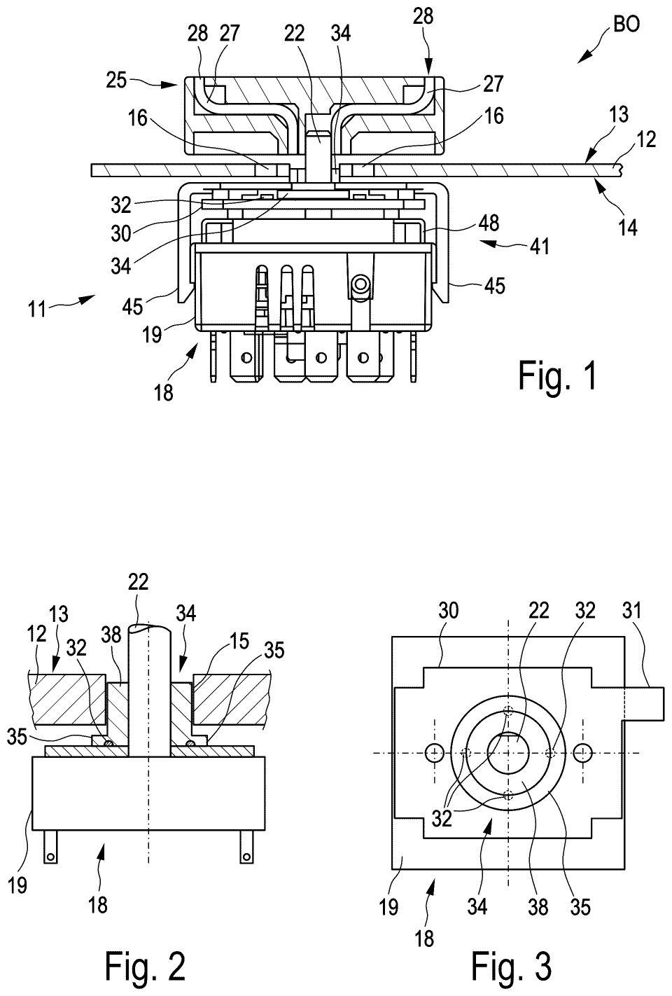

FIG. 1 shows a section of an oven BO according to the invention, on the front panel of which, advantageously above an oven door, a control panel 12 is arranged. The control panel 12 has a front face 13 and a rear face 14. It may consist of glass, metal or plastic. Furthermore, an operating device 11 is provided, in this case for rotary control, on this control panel 12. The operating device 11 also has a rotary control unit 18 with a device housing 19. Advantageously, an encoder is arranged in the rotary control unit 18, see for example U.S. Pat. No. 7,076,324 B2 in this respect. It has a rotary shaft 22, of which the rotation angle or the rotation can be detected and evaluated in order to generate a corresponding control command. In addition to the rotary control unit 18, the operating device 11 may have further functional devices, not shown here, for example switches, touch switches, illuminated display units, displays or the like.

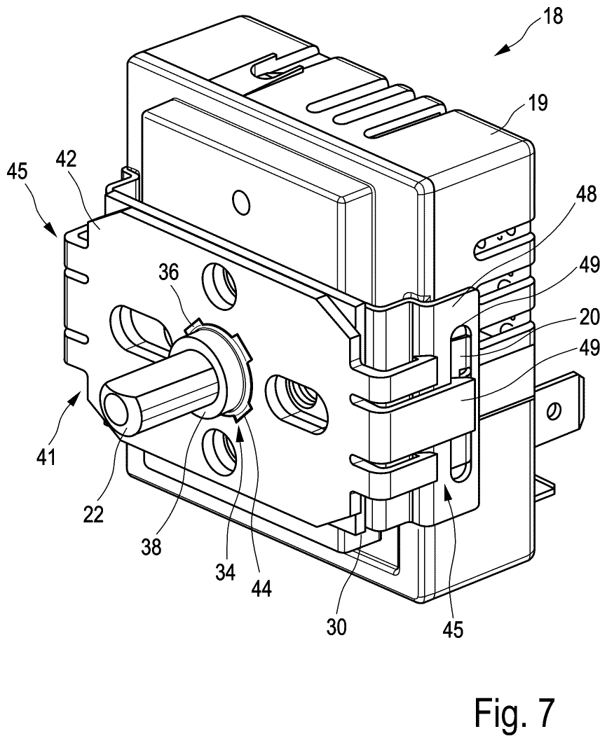

The rotary shaft 22 extends through a panel opening 15 in the control panel 12. It is, as shown by FIG. 7 below, rounded on one side in a known manner as a D-shaped shaft. A rotary knob 25, which may be rotated manually by one person for control, is fitted onto this rotary shaft 22.

The rotary knob 25 has in its interior light guides 27 extending from a central area facing towards the control panel 12. They then extend radially outwards and relatively close to an outer rim of the rotary knob 25 as far as its front face, where they form illuminated areas 28. Otherwise, the light guides 27 may be not visible or extend inside the rotary knob 25. These illuminated areas 28 may form either a completely surrounding illumination ring, alternatively illumination bars, illumination dots or the like. Many variations are possible here which are known to a person skilled in the art and may be easily implemented. The light guide 27 may also be segmented or subdivided. To couple the light into the light guide 27, a light guiding ring 34 in accordance with the invention is provided. It starts behind the control panel 12 and extends through the panel opening 15, wherein it does not protrude beyond the plane of the front face 13.

FIG. 2 shows the rotary control unit 18 with the device housing 19 from the side in a simplified representation. A printed circuit board 30 is arranged at the front on the rotary control unit 18. On its side facing away from the rotary control unit 18 and towards the control panel 12, four LEDs 32 are provided. This is also shown by the front view onto the rotary control unit 18 from FIG. 3. As may be discerned, the light guiding ring 34 is fitted from the front onto the printed circuit board 30, wherein it protrudes beyond the LEDs 32 with a surrounding and protruding collar 35. An annular extension 38 extends from the collar 35 and away from the rotary control unit 18, and is then arranged or inserted in the panel opening 15 of the control panel 12.

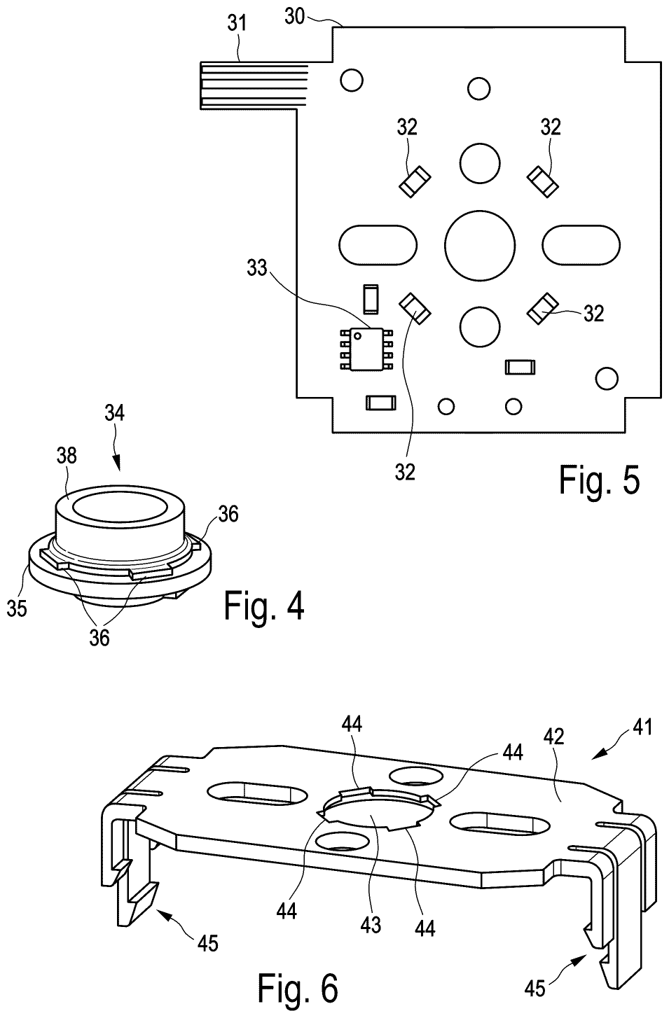

FIG. 4 shows a detailed representation of this light guiding ring 34. On the top of the collar 35, four projections 36 are arranged evenly distributed, above which the annular extension 38 rises. Their function is explained in more detail in the following. Apart from the projections 36, the light guiding ring 34 can be largely rotation symmetrical.

FIG. 5 shows an alternative embodiment of a printed circuit board 30 in an oblique view. A contact projection 31 projects upwards from the printed circuit board 30 as a tab or lug. Elongate contact fields, which are the ends of contact paths extending on the printed circuit board 30, are arranged on this contact projection 31. A plug for electrical contact may be fitted in known manner onto the contact projection 31. The elongate contact fields such as pin terminals are overlapped and contacted as a result.

On the upper face of the printed circuit board 30 shown in FIG. 5, four LEDs 32 are arranged evenly around an opening. The rotary shaft 22 protrudes through this opening in accordance with FIGS. 2 and 3. The LEDs 32 are designed as SMD components and hence are very small. A microcontroller 33, advantageously designed as an IC, is also located on the printed circuit board 30. This can control the LEDs 32 with control commands, which like the power supply are received via the contact projection 31. In this embodiment, the collar 35 of the light guiding rings 34 does not protrude beyond the LEDs 32, i.e. unlike in FIGS. 2 and 3. However, the LEDs 32 here shine from the side into the collar 35, so that their light also passes into the light guiding ring 34 and is guided forwards into the annular extension 38.

FIG. 6 shows a holding part 41 with which the light guiding ring 34 and the printed circuit board 30 may be arranged on the rotary control unit 18 or on its device housing 19, as shown in FIG. 7. The holding part 41 has a large-area holding section 42 which is designed smooth and flat. In the center it has a hole 43 through which extend the rotary shaft 22 and also the light guiding ring 34 with annular extension 38. The hole 43 has on the rim four cutouts 44 that correspond to the projections 36 of the light guiding ring 34. As shown in FIG. 7, the light guiding ring 34 can thus be held in a precise position and undetachably therein.

Three gripping hooks 45 protrude from each of the two opposite ends of the elongate holding section 42. A middle gripping hook 45 is slightly longer and wider, and hence stronger, than the two outer ones. This allows the holding part 41 to be used for different rotary control units 18.

As shown in FIG. 7, a fastening plate 48 is arranged on or fastened to the rotary control unit 18 at the front. It is snapped into place with elongate fastening openings 49 which snap over one wide engaging projection 20 or several engaging projections on the side of the device housing 19. Hence the fastening plate 48 is detachable, but arranged firmly on the rotary control unit 18. It thus forms with the latter a functional unit and a structural unit. The printed circuit board 30 is located at the front on the fastening plate 48, advantageously at some distance therefrom. Its upper face shown in FIG. 5 with the four LEDs 32 here faces in the direction away from the rotary control unit 18 or the fastening plate 48. In front of the printed circuit board 30, the holding part 41 is in turn located, and engages in the same fastening opening 49 of the fastening plate 48 with the middle gripping hook 45. As a result, the printed circuit board 30 together with the light guiding ring 34, which is seated in front with the collar 35, is held between the holding part 41 and the fastening plate 48, and arranged at the front on the rotary control unit 18 or on the device housing 19. The holding part 41 and/or the fastening plate 48 can have spacers, so that the printed circuit board 30 has a certain distance from one of them or from both of them, in particular also from the improved electrical insulation. Furthermore, it may be discerned that holes are provided in the holding part 41, and accordingly also on the fastening plate 48, that lead to a thread either in the fastening plate 48 or on the front face of the device housing 19, and also have a thread. It is possible here for screws to grip through the screw openings 16 in the control panel 12 and to be used for fastening the rotary control unit 18 to the control panel 12 together with the structure according to FIG. 7. These screw openings 16 together with corresponding screws are covered by the rotary knob 25 as shown in FIG. 1, ensuring a neat optical arrangement.

Similarly to what was described above for the light guide 27 in the rotary knob 25, the light guiding ring 34 too can be segmented into two or more parts. This means that light shining in from one of the LEDs 32 extends only inside the segment directly located there, and does not shine into other segments. Accordingly, it may also then be provided that only one segment or one segment-like illuminated area 28 at the front on the rotary knob 25 is illuminated.

1. An operating device for an electrical appliance, in particular for an oven as said electrical appliance, wherein said operating device has:
a control panel with a front face and with a rear face,
a rotary control unit arranged on said rear face of said panel and having a rotary shaft, wherein said rotary shaft extends through a panel opening in said control panel and protrudes beyond said front face of said control panel,
a control knob on said rotary shaft, said control knob being arranged on said front face of said control panel,
wherein
said rotary control unit has a light source,
a light guiding device is arranged in said panel opening and extends to behind said panel opening as far as said light source,
said light guiding device has solid light guiding material and surrounds said rotary shaft at least partially, such that said light guiding device extends in annular manner around said rotary shaft in said panel opening,
illuminated areas made of light guiding material are provided in said control knob, and extend from a rear face of said control knob close to said light guiding device to a lateral face of said control knob or to a front face of said control knob.

2. The operating device according to claim 1, wherein said panel opening has a diameter between 10% and 100% greater than a maximum diameter of said rotary shaft, wherein said rotary shaft extends with its axis of rotation through a center point of said panel opening.

3. The operating device according to claim 1, wherein said light guiding device does not protrude beyond said front face of said control panel, or if so only by no more than 5 mm, and does not extend laterally or radially outside said panel opening at said front face in a projecting area.

4. The operating device according to claim 3, wherein said light guiding device does not protrude beyond said front face of said control panel or ends behind said front face or in said panel opening.

5. The operating device according to claim 1, wherein said light guiding device is arranged permanently and unrotatably fastened to said rotary control unit.

6. The operating device according to claim 1, wherein said light guiding device extends completely around said rotary shaft in said panel opening, wherein said light guiding device takes up between 50% and 95% of an intermediate space between an inner rim of said panel opening and said rotary shaft.

7. The operating device according to claim 1, wherein said light guiding device is made up of a single light guiding material.

8. The operating device according to claim 1, wherein said light guiding device has several light guiding sections that are separated from one another or are separated opaquely from one another, wherein said light guiding sections extend from a rear area facing said rotary control unit to a front area facing towards said control knob.

9. The operating device according to claim 8, wherein said light guiding sections form annular sectors and are separated from one another by opaque separators.

10. The operating device according to claim 1, wherein at least one light source is arranged on said rotary control unit, and said light guiding device extends close to said light source, wherein said rotary control unit covers or shields said at least one light source into an interior of said operating device or of said electrical appliance having said operating device, such that said rotary control unit is arranged between said at least one light source and said interior of said operating device or of said electrical appliance or such that said at least one light source is arranged between said rotary control unit and said control panel.

11. The operating device according to claim 10, wherein said at least one light source is arranged on a flat component carrier being arranged at said front on said rotary control unit towards said control panel, wherein said component carrier is arranged outside a housing of said rotary control unit and on a front side of said housing facing towards said control panel.

12. The operating device according to claim 11, wherein said component carrier is fastened by means of a holding part overlapping it from said front to said rotary control unit or to said housing of said rotary control unit, such that said component carrier is between said holding part and said rotary control unit.

13. The operating device according to claim 12, wherein said holding part has a planar holding section arranged between said component carrier and said rear face of said control panel, wherein said surface of said holding section shields or directly covers said at least one light source towards said rear face of said control panel.

14. The operating device according to claim 11, wherein said light guiding device extends through said holding part or through said planar holding section up to said at least one light source arranged behind it, wherein said light guiding device is arranged in a defined position and positively and nonrotatably in a passage opening in said holding section.

15. The operating device according to claim 11, wherein two to six light of said sources are arranged on said component carrier around said rotary shaft.

16. The operating device according to claim 11, wherein a microcontroller is provided on said component carrier for controlling said at least one light source.

17. The operating device according to claim 11, wherein an electrical contact device is arranged on said component carrier on an outer face or outer edge of said component carrier, wherein said electrical contact device has contact fields onto which a contact plug is fittable so as to overlap said contact fields.

18. The operating device according to claim 11, wherein said component carrier is undetachably fastened to said holding part, wherein said component carrier is fastened to said holding part by means of snapping, glueing or riveting.

19. The operating device according to claim 18, wherein said component carrier is undetachably fastened to said holding part together with said light guide in a final assembly state.

20. The operating device according to claim 11, wherein said component carrier has a certain distance from said front face of said rotary control unit or a certain distance from said rear face of said holding part as an installation space for electrical connections or components on said component carrier.

21. The operating device according to claim 1, wherein said rotary control unit is fastened with at least one screw to said control panel, wherein said screw extends from said front face of said control panel through a screw opening and engages in a thread on said rotary control unit.

22. The operating device according to claim 20, wherein a holding part is provided, said holding part overlapping a component carrier from said front to said rotary control unit or to a housing of said rotary control unit, such that said component carrier is between said holding part and said rotary control unit, wherein said screw also extends through said holding part and through said component carrier.

23. An electrical appliance with least one operating device according to claim 1, wherein said control panel is arranged on an outer face of said electrical appliance.

24. The electrical appliance according to claim 22, wherein said control panel is arranged on an upper face or on a front face of a housing of said electrical appliance.

25. The electrical appliance according to claim 22, wherein said control panel is formed by an upper face of a housing or by a front face of a housing of said electrical appliance.
